(19) United States
(12) Patent Application Publication
(10) Pub. No.: US 2026/0065405 A1
(43) Pub. Date: Mar. 5, 2026

(54) GRAPHICS PROCESSING

(71) Applicant: Arm Limited, Cambridge (GB)

(72) Inventors: Peter William Harris, Cambridge (GB); Christian Forfang, Nesoya (NO); Tord Kvestad Øygard, Kirkenes (NO); Rafal Stepuch, Cambridge (GB)

(73) Assignee: Arm Limited, Cambridge (GB)

(21) Appl. No.: 18/818,264

(22) Filed: Aug. 28, 2024

(51) Int. Cl. G06T 1/20; G06T 11/20

(52) U.S. Cl. CPC G06T 1/20; G06T 11/23; G06T 2210/12

(57) ABSTRACT

When generating binning data structures for identifying primitives to be processed for respective rendering tiles for a render output being generated using tile-based rendering, for one or more primitives to be included in a binning data structure, a depth of the primitive at one or more sampling positions that are covered by the primitive is determined and included in the binning data structure with respect to the primitive.

### BACKGROUND

The technology described herein relates to computer graphics processing, and in particular to tile-based graphics processing.

Graphics processing is normally carried out by first splitting a scene (e.g. a 3D model) to be rendered (e.g. for display) into a number of similar basic components or “primitives”, which primitives are then subjected to the desired graphics processing operations. The graphics primitives are usually in the form of simple polygons such as triangles, quadrilaterals, points, lines or groups thereof.

Each primitive is usually defined by and represented as a set of vertices (e.g. three vertices in the case of a triangular primitive). The vertices that are to be used for the primitives will have respective sets of vertex data defining the vertices, e.g. the relevant attributes for each of the vertices. These attributes will typically include position data and other, non-position data, e.g. defining colour, light, normal, texture coordinates, etc., for the vertex in question.

In tile-based graphics processing, the two-dimensional graphics processing (render) output (i.e. the output of the rendering process, such as an output frame to be displayed) is generated (rendered) as a plurality of smaller area regions, usually referred to as “tiles”. The render output is typically divided (by area) into regularly-sized and shaped rendering tiles (they are usually e.g. squares or rectangles). The tiles are each rendered separately (e.g. one after another). The rendered tiles are then combined to provide the complete render output (e.g. frame for display).

When performing tile-based graphics processing, there will normally be some initial geometry processing, such as vertex processing (vertex shading) of attributes for vertices to be used for primitives for the render output being generated, to generate geometry (and other) data required for rendering the graphics processing output.

The geometry processing will then be followed by a tiling/binning process that generates appropriate “binning” data structures for determining which geometry (e.g. primitives) needs to be processed for respective rendering tiles of the output being generated.

(In tile-based graphics processing, it is usually desirable to be able to (try to) identify the geometry (e.g. primitives) for the render output that need to be processed for a given rendering tile (so as to avoid unnecessarily processing geometry that does not actually apply to a rendering tile). To facilitate this, in tile-based graphics processing, there is usually a tiling/binning process that is performed that generates appropriate binning data structures, such as lists of primitives that apply to a tile or tiles, for use then to identify geometry that need to be processed for a respective rendering tile.)

Once the binning/tiling process has generated the necessary binning data structures for identifying geometry to be processed for respective tiles of the render output, the geometry can then be, and will be, subjected to appropriate rendering/fragment processing. This may comprise, for example, rasterising primitives to be processed to fragments, fragment shading of the fragments, and/or performing ray tracing operations. This operation is performed on a tile-by-tile basis, using the binning data structures generated by the tiling/binning process to identify the geometry (e.g. primitives) that need to be processed for a respective rendering tile.

The rendered tiles may then be combined appropriately to provide the overall render output (e.g. frame for display).

The Applicants believe that there remains scope for improvements to the operation of tile-based graphics processors and tile-based graphics processing.

### BRIEF DESCRIPTION OF THE DRAWINGS

Embodiments of the technology described herein will now be described by way of example only and with reference to the accompanying drawings, in which:

FIG. 1 shows an exemplary graphics processing system in which the technology described herein may be implemented;

FIG. 2 shows an exemplary processing sequence of a graphics processing pipeline in which the technology described herein may be implemented;

FIG. 3 shows an exemplary graphics processing pipeline;

FIG. 4 shows a graphics processing pipeline in accordance with an embodiment;

FIG. 5 shows a flowchart illustrating the generation of data structures according to an embodiment;

FIG. 6 shows schematically the storage of two primitives according to an operation according to an embodiment;

FIGS. 7a and 7b show schematically binning data structures according to embodiments;

FIG. 8 shows schematically a graphics processing pipeline according to an embodiment; and

FIG. 9 shows a flowchart illustrating the processing of primitives in a binning data structure according to an embodiment.

Like reference numerals are used for like features in the Figures, where appropriate.

### DETAILED DESCRIPTION

A first embodiment of the technology described herein comprises a method of operating a graphics processor when performing tile-based rendering in which a render output to be generated is divided into a plurality of tiles for rendering purposes, with tiles of the render output being rendered separately, the method comprising:
generating binning data structures for identifying primitives to be processed for respective rendering tiles of a render output being generated; and
rendering respective tiles of the render output including using the binning data structures to identify primitives to be processed for rendering tiles;
the method further comprising, when generating binning data structures for identifying primitives to be processed for respective rendering tiles for a render output being generated:
for one or more primitives to be included in a binning data structure:
   determining a depth of the primitive at one or more sampling positions that are covered by the primitive; and
   including the determined depth or depths of the primitive in the binning data structure with respect to the primitive.

A second embodiment of the technology described herein comprises a graphics processor operable to perform tile-based rendering, in which a render output to be generated is divided into a plurality of tiles for rendering purposes, with tiles of the render output being rendered separately, the graphics processor comprising:
a binning circuit configured to generate binning data structures for identifying primitives to be processed for respective rendering tiles of a render output being generated;
a rendering circuit configured to render respective tiles of the render output and use the binning data structures to identify primitives to be processed for rendering tiles; and
a depth determining circuit configured to determine a depth of a primitive at one or more sampling positions covered by the primitive;
wherein the binning circuit is operable to, when generating binning data structures for identifying primitives to be processed for respective rendering tiles for a render output:
   include in a binning data structure with respect to a primitive, a depth of the primitive at a sampling position that is covered by the primitive determined by the depth determining circuit.

The technology described herein relates to tile-based graphics processing. In tile-based graphics processing, “binning” data structures are generated and used when identifying primitives to be processed for respective rendering tiles of a render output. Such “binning” data structures store data for identifying primitives to be processed for respective rendering tiles.

In the technology described herein, depth values of primitives at sampling positions that are covered by the primitives can be (and at least in certain circumstances are) determined and stored in a binning data structure(s) with respect to the primitives. This may then allow depths of primitives at sampling positions to be (directly) read from binning data structures during subsequent processing (and not, for example, have to be calculated from the positions of the vertices of the primitives).

As such, and as will be discussed further below, storing depth values in the binning data structures may allow the subsequent stages to be performed without having to determine sampling positions covered by primitives, and the depths thereof, during those subsequent stages. This therefore may reduce latency when performing the subsequent stages of the render pipeline.

Using the stored depth values in subsequent stages of the render pipeline may also allow at least some primitives to be processed (e.g. culled or used in subsequent processing) without having to fetch vertex positions for the primitives, and therefore, at least in some circumstances, the technology described herein may allow the data that must be fetched from memory to be reduced.

In particular, the Applicants have identified that, for certain so-called “depth-only” renders, the depth of sampling positions covered by a primitive is the only positional information required for the primitive, and for a significant proportion of primitives there may be no non-positional inputs (i.e. there may be no non-position data required). An example of such a “depth-only” render operation is shadow mapping.

For such “depth-only” renders, storing depths (directly) in the binning data structure(s) with respect to primitives reduces the data that must be read and the processing that must be performed to perform the rendering operation (for example by allowing for the depth to be obtained without having to fetch vertex position data and calculate depth therefrom), thereby reducing the required bandwidth and reducing latency.

The technology described herein may be similarly beneficial when performing (e.g. initial) processing passes to determine primitives that are visible (and which can then be “fully” processed in a subsequent processing pass).

The technology described herein generally relates to the generation of a render output. The render output may comprise any suitable render output, such as a frame for display, or render-to-texture output, etc.

The render output comprises an (in embodiments regular) array of sampling positions (e.g. pixels), for each of which appropriate render output data (e.g. a set of colour value data) is generated by the graphics processor. The graphics processing data may comprise colour data, for example, a set of red, green and blue, RGB values and a transparency (alpha, a) value.

The array of sampling positions may be any suitable array of sampling positions, as desired.

As noted above, the technology described herein relates to tile-based graphics processing, in which an overall output should be, and in embodiments is, generated on a tile-by-tile basis. The render output (area) should thus be, and in embodiments is, divided into plural rendering tiles for rendering purposes.

The tiles that the render output is divided into for rendering purposes can be any suitable and desired such tiles. The size and shape of the rendering tiles may normally be dictated by the tile configuration that the graphics processor is configured to use and handle.

In an embodiment the rendering tiles are all the same size and shape (i.e. in an embodiment regularly sized and shaped tiles are used), although this is not essential. The tiles are in an embodiment rectangular, and in an embodiment square. The size and number of tiles can be selected as desired. Each tile may correspond to an array of contiguous sampling positions, for example each tile being 16×16 or 32×32 or 64×64 sampling positions in size (wherein each sampling position may correspond to a pixel, or sub-pixel, for the render output). The render output may be divided into however many such tiles are required to span the render output, for the size and shape of the render output that is being used.

In the technology described herein, the graphics processor generates binning data structures for identifying primitives to be processed for respective rendering tiles of a render output being generated. These binning data structures are then used when rendering respective tiles of the render output to determine primitives to be processed for the rendering tile.

In an embodiment, the binning data structures are generated in a first processing pass, and are then used in a second processing pass. The second processing pass can be, and in embodiments is, performed after the binning data structures have been generated in the first processing pass. The second processing pass uses the (previously generated) information (data) generated in the first processing pass to, when rendering a (and in embodiments, each) tile of the render output, determine which primitives to process to generate the (respective) rendering tile, and processes the determined primitives to generate the (respective) rendering tile of the render output.

The primitives which are to be processed for the render output (and for which binning data structures are generated) may comprise any suitable (and, e.g., suitably “standalone”) set of primitives for the render output, such as the set of primitives for generating the entire (complete) render output, or (in an embodiment) a set of primitives for generating a respective portion of the render output (e.g. corresponding to a draw call).

Prior to the generation of the binning data structures, the set of primitives may be (and is in an embodiment) assembled. Assembling the set of primitives may be performed in any suitable and desired manner. For example, primitive assembly may comprise receiving information (e.g. indices) identifying vertices of a set of vertices to be used to form the primitives of the set of primitives, and then assembling primitives (determining the vertices corresponding to each primitive of the set of primitives) using the information (e.g. indices) identifying the vertices. The primitive assembly may be performed in accordance with information (primitive configuration information) indicating how the primitives are to be assembled, e.g. indicating whether primitives in the form of simple triangles, triangle strips, or triangle fans, etc., should be generated from the set of vertices.

Subject to the technology described herein, the binning data structures that are generated for identifying primitives to be processed for respective rendering tiles of a render output being generated may be any suitable and desired binning data structures for identifying primitives to be processed for a rendering tile.

A (and each) binning data structure therefore should, and does in an embodiment, allow a region (an area) of the render output to which the binning data structure corresponds be identified, and also include information that allows primitives to be processed for that region (area) to be identified and processed accordingly.

In some embodiments, a (and in an embodiment each) binning data structure is associated with a (respective) particular, pre-determined region of the render output, with (e.g. all of the) primitives to be processed for that region of the render output included (“listed”) in the corresponding binning data structure(s).

For example, in some embodiments, the binning data structures comprise primitive lists, each primitive list identifying (listing) one or more primitives which are to be processed for a respective region (area) of the render output in question.

The regions for which primitive lists are prepared in an embodiment encompass (correspond to) one or more rendering tiles of the render output. For example, a primitive list region may correspond to a single rendering tile, or a set of plural rendering tiles. In an embodiment a region for which a primitive list is prepared corresponds to one or more contiguous tiles (and thus spans an array of contiguous sampling positions). A (and each) region for which a primitive list is prepared is in an embodiment rectangular (and in an embodiment square).

In an embodiment, there are one or more sets of regions for which primitive lists can be prepared, with the regions in different sets of regions in an embodiment differing in size (area).

In an embodiment, the sets of regions are arranged in a hierarchy of sets of regions, wherein each set of regions corresponds to a layer in the hierarchy of sets of regions, and wherein regions in progressively higher layers of the hierarchy are progressively larger. Each set of regions (corresponding to a layer in the hierarchy) in an embodiment spans the (entire) render output, such that the render output is effectively overlaid by plural layers of sets of regions (and accordingly wherein regions in different layers in the hierarchy may overlap one another).

In such embodiments, where the binning data structures comprise primitive lists, using the binning data structures for identifying primitives to be processed for rendering tiles comprises reading one or more primitive lists associated with the rendering tile, and using the primitive list(s) to identify primitives to be processed for the rendering tile.

In some (other) embodiments, rather than “sorting” primitives into binning data structures that correspond to particular, pre-determined regions of the rendering output, (sets of) primitives may (instead) be assigned to binning data structures in other ways. In such embodiments, the binning data structure may comprise (further) data that enables which rendering tiles of a render output primitives in the binning data structure are to be processed for.

For example, and in some embodiments, the data that enables which rendering tiles of a render output primitives in a (and in an embodiment each) binning data structure are to be processed for comprises, (and therefore the binning data structures comprise), in an embodiment hierarchies of, bounding boxes that can be used for that purpose.

Thus, in embodiments, generating binning data structures for identifying primitives comprises generating a set of (plural) bounding boxes representative of positions of primitives, and writing out (e.g. to memory) information (data) representative of the set of (plural) bounding boxes. In such embodiments, rendering respective tiles of the render output by using the binning data structures comprises reading in (e.g. from memory) the information (data) representative of the set of (plural) bounding boxes, and using the information (data) to determine which primitives to process to generate a (each) rendering tile.

The set of bounding boxes can be any suitable set of bounding boxes that represents primitive positions (e.g. in screen space), and that can be used to determine which primitives to process for which rendering tiles. In embodiments, the bounding boxes are two-dimensional bounding boxes, e.g. polygons such as rectangles. The set of bounding boxes may include one or more bounding boxes that each bound only one primitive, and/or one or more bounding boxes that each bound plural primitives.

In embodiments, the set of bounding boxes comprises (at least) a set of (two-dimensional) primitive bounding boxes, wherein each primitive bounding box bounds a respective primitive of the set of (assembled) primitives to be processed to generate the render output. In embodiments, the set of bounding boxes includes a respective primitive bounding box for each primitive of the set of (assembled) primitives to be processed to generate the render output.

A primitive bounding box can be provided in any suitable manner. In embodiments, a (each) primitive bounding box is generated using vertex positions of a respective primitive. In embodiments, as discussed above, vertex positions are subject to vertex processing operations to transform them (e.g. to a screen space), and a (each) primitive bounding box is generated using transformed vertex positions. A (each) primitive bounding box may be, for example and in embodiments, e.g. a rectangle, determined from (and e.g. defined by) minimum and maximum (transformed) vertex positions of a respective primitive (e.g. in x and y screen space dimensions).

In embodiments, the set of bounding boxes is a (e.g. nested) hierarchy of (two-dimensional) bounding boxes, that e.g. comprises a respective set of bounding boxes for each “level” of plural levels of the hierarchy. In embodiments, a (each) primitive that the hierarchy of bounding boxes represents is bounded by plural different sized (two-dimensional) bounding boxes (at plural different “levels”) of the hierarchy of bounding boxes. In embodiments, the set of primitive bounding boxes represents a “lowest level” of the hierarchy of bounding boxes, and the hierarchy includes one or more “higher levels” that are each represented by a respective set of “higher level” bounding boxes.

In embodiments, a (each) higher level bounding box bounds a (respective) subset of the set of bounding boxes at the next lowest level of the hierarchy. A (each) higher level bounding box may be, for example and in embodiments, e.g. a rectangle, determined from (and e.g. defined by) minimum and maximum positions of the lower-level bounding boxes which the higher-level bounding box bounds (e.g. in x and y screen space dimensions).

In such embodiments, to identify primitives to be processed for a rendering tile, the rendering tile can be compared to the (hierarchies of) bounding boxes to determine whether the primitives for a (and each) binning data structure are to be processed for that rendering tile.

In such embodiments, the (sets of) primitives to be included in a (and each) data structure may be determined in any suitable and desired way.

For example, and in embodiments, primitives may be organised as packets of primitives, e.g. substantially as described in US 2024/0169464 A1, the entire content of which is incorporated herein by reference.

In such embodiments, assembled primitives are assigned to one or more packets of one or more primitives. In embodiments, the one or more packets are then processed to transform the geometry data and/or generate the data to be used in a subsequent processing pass.

Packets may be generated in any suitable manner. In embodiments, assembled primitives are assigned to packets in order. In embodiments, a packet has a fixed capacity, e.g. an upper limit of vertices and/or primitives, and when the fixed capacity is reached, a new packet is started. There may be an upper limit of vertices of, for example, 64, 128 or 256 vertices, and/or an upper limit of primitives of, for example, 64, 128 or 256 primitives. Other numbers would be possible.

Each packet may store any suitable and desired data for one or more primitives that it relates to. For example, a packet may, and in an embodiment does, store appropriate attributes such as positions and non-position data, for a set of (in an embodiment plural) vertices for the set of primitives that the packet relates to, for example, and in an embodiment, together with a set of identifiers (indices) for the vertices that can be used to determine how the vertices are used for the primitives that the packet relates to.

In such embodiments, the binning data structures in an embodiment comprise further data that can be (and is) used to determine whether packets storing data for primitives to be processed should be processed for a rendering tile.

The binning data structures therefore may comprise any such suitable further data that allows packets to be processed for a rendering tile to be identified. For example, and in an embodiment, the binning data structures may further comprise lists of packets to be processed for respective rendering tiles or sets of plural rendering tiles (which packet “tile” lists can then be used to determine which packets apply to a given tile).

In an embodiment, the further data that can be used to determine whether packets store data for a set of one or more primitives to be processed for a rendering tile comprises (and therefore the binning data structures comprise), in an embodiment hierarchies of, bounding boxes that can be used for that purpose. In an embodiment, this comprises both bounding boxes for individual packets, together with bounding boxes for respective groups of plural packets (and, if desired, for respective groups of groups of plural packets, and so on, if desired).

In this case, to determine packets that should be processed for a rendering tile, the rendering tile can, and will be, compared against the respective bounding boxes to identify those packets that apply to the tile.

Subject to the operation in the manner of the technology described herein, other binning data structures that enable primitives to be processed for rendering tiles to be identified for rendering tiles may, of course, be used as desired.

Along with allowing primitives are to be processed for regions of a render output to be identified, the binning structures may, and do in an embodiment, include (further) data for use when processing primitives.

The data for use when processing primitives may be any suitable and desired data for primitives. For example, and in embodiments, the data may comprise vertex information for primitives. In an embodiment, the vertex information for a primitive comprises vertex indices for a (and in an embodiment each) vertex of the primitive, wherein the vertex indices indicate which vertices should be used when processing the primitive.

In the operation in the manner of the technology described herein, for a render output being generated, for one or more primitives to be included in a binning data structure, a depth of the primitive at one or more sampling positions is determined and included in the data structure with respect to the primitive.

It will be appreciated that, when generating binning data structures, for example when sorting primitives into lists for regions of the render output or when determining one or more bounding boxes are determined for the primitive, transformed (i.e. screen space) positions for the vertices of the primitives should be (and are) determined (for example to allow bounding box(es) for the primitive to be determined, or to determine which primitive list(s) to include the primitive in).

The Applicants have appreciated that this transformed vertex data is (also) used when calculating the depth of a primitive at one or more sampling positions. Typically, depth would be calculated later in the graphics processing pipeline (e.g. when performing rasterization). However, this typically requires fetching vertex position data from memory, and then processing this position data to calculate depth.

By calculating the depth earlier in the graphics processing pipeline, and storing it when generating binning data structures for identifying primitives to be processed for respective rendering tiles of a render output being generated, the technology described herein may reduce the bandwidth required for later stages of the graphics processing pipeline, as the (stored) depths can be used to perform at least some subsequent stages of the graphics processing pipeline without fetching “full” vertex data for the primitive.

For example, the subsequent processing may comprise using the stored depths to perform hidden surface removal (thereby culling at least some primitives), without requiring “full” vertex data for primitives that are culled to be fetched.

Furthermore, in some embodiments where only depth is required for fragment shading (e.g. “depth-only” render operations”), the storage of depths for sampling positions covered by a primitive in the binning data structure(s) in the manner of the technology described herein may allow the depths to be fetched (directly) from the binning data structures in subsequent stages of the graphics processing pipeline, without having to fetch “full” vertex data at all.

The storage of depths for covered sample positions in the binning data structures in the manner of the technology described herein may generally reduce the amount of data that must be fetched during subsequent stages of the graphics processing pipeline.

For example, and in an embodiment, vertex position data may be stored in a 32-bit floating-point format (other formats are, of course, possible in this regard as desired). For a primitive in the form of a triangle, three-dimensional co-ordinates of each of the three vertices of the primitive may require three such values per vertex, and so a total of 288 bits may be required to fetch the primitive vertex positions (as required to determine depth, for example for hidden surface removal).

In contrast, the depth of the sample may be, and in an embodiment is, stored as a single 32-bit value, along with, in an embodiment, a 12-bit sample index, per sampling position.

Furthermore, by storing depth directly in the binning data structure and using this depth when performing subsequent stages of the graphics processing pipeline, the technology described herein allows at least some later stages of the graphics processing pipeline (such as hidden surface removal) to be performed without requiring additional fetching of data and calculation to determine depth, thereby reducing latency.

It will also be appreciated that some primitives may not cover any sampling positions. In an embodiment, if a primitive does not cover any sampling positions, no data is stored in a data structure with respect to the primitive. As such, the operation in the manner of the technology described herein allows for such primitives that cover no sampling positions, if desired, to be culled during the generation of the binning data structure, thereby reducing the amount of data that needs to be stored in binning data structures.

In some embodiments, as well as storing depth information in binning data structures with respect to a primitive, vertex information for the primitive (e.g. vertex indices for identifying vertices to be processed for a primitive) is also stored, for example and in embodiments in the usual way for the graphics processor. In some embodiments, vertex information is stored with respect to each primitive included in a binning data structure.

In this way, the depth may be used (directly) to perform certain subsequent stages of the graphics processing pipeline, for example hidden surface removal, whilst the vertex information can be used to perform (other) subsequent stages of the graphics processing pipeline (for example colour calculations).

Furthermore, in some embodiments, when determining and including a depth of one or more sampling positions covered by a primitive in a binning data structure with respect to a primitive, other (e.g. non-position) data for the covered sampling position(s) is determined and included in the data structure with respect to the primitive. The other data that may be included in the data structure with respect to the primitive may be any suitable and desired for the sampling position, for example non-position data. The other data may, and does in an embodiment, include all of the necessary other data for the sampling position for one or more subsequent stages of the graphics processing pipeline to be performed for the sampling position.

In some embodiments, the depth information with respect to a primitive is stored instead of storing vertex information for the primitive. As such, in embodiments, for one or more primitives, including data in the binning data structure with respect to the identified primitive comprises including the determined depths of the primitive in the binning data structure with respect to the primitive without storing vertex information for the primitive in the binning data structure.

In this regard, the Applicants have recognised that the technology described herein may be particularly beneficial for certain rendering operations, where the depth of covered sampling positions is the only position information required for a primitive (so-called “depth-only” renders), and where (at least for a significant proportion of primitives) there may be no non-positional inputs (i.e. there may be no non-position data required).

One such depth-only render is shadow mapping, where a view of a scene is rendered from the point of view of a light source (e.g. the sun), to determine which surfaces are “visible” to the light source, and a map (a so-called “shadow map”) of the depths is stored, for example as a texture in memory. The shadow map can then be used when rendering a scene to determine whether a position in the scene being rendered is visible to the light source (and so is not in shadow), or not.

In such depth-only operations, by storing the depth in the binning data structure with respect to a primitive, subsequent processing stages can be performed by reading the depths (directly) from the binning data structures, without fetching vertex information (at all).

The operation in accordance with the technology described herein may similarly be beneficial when performing an initial processing pass to determine which primitive(s) should be processed for a particular sampling position. This may then be followed by a subsequent processing pass that generates “full” information for sampling positions using (e.g. only) the primitives determined as needing to be processed in the first pass.

It will be appreciated that, for some (other) rendering operations, the vertex positions for the primitive may still be required (for example, where vertex positions are required for colour calculation).

In this case, it would be possible to (still) store depths in binning data structures in in the manner of the technology described herein (e.g. to use for some subsequent stages of the graphics processing pipeline (for example hidden surface removal)), for example along with vertex information (e.g. vertex indices) or other (e.g. non-position) data with respect to the primitive, and obtain vertex position data in subsequent stages of the graphics processing pipeline where it is required as necessary, and in an embodiment that is what is done. However, the Applicants have appreciated that in such a case this may not be as efficient as (simply) calculating the depth using (fetched) position data.

As such, in embodiments, the storage of depths in binning data structures in the manner of the technology described herein may be selectively enabled. In some embodiments, the storage of depths in the manner of the technology described herein is enabled on a render output-by-render output (e.g. draw call) basis.

In this regard, the Applicants have identified that the benefits of storing depth may be larger in certain circumstances, such as for particular rendering operations. For example, as described above, storing depths may be particularly beneficial for rendering operations where only depth is required for fragment shading (e.g. where there is no colour calculation).

As such, in embodiments, the (potential) storage of depths in the manner of the technology described herein is enabled for a draw call, e.g., and in an embodiment, based on the render operation to be performed. In some embodiments, the storage of depths in the manner of the technology described herein is enabled for render operations where the depth of covered sampling positions is the only position information required for a primitive (i.e. for “depth-only” render operations).

Furthermore, the Applicants have recognised that storing depth may be particularly beneficial for certain primitives. In particular, smaller primitives (that cover fewer sampling positions), require less data to store the depth of the primitive at (each of) the covered sampling positions (and therefore less data must be fetched when using the binning data structures).

In particular, the Applicants have identified that, in certain rendering operations, there may be many primitives that only cover a small number of sampling positions, and therefore can be particularly efficiently included in binning data structures in the manner of the technology described herein. One example is shadow mapping, as described above, which may commonly involve rendering a view of a scene from the point of view of the sun, high above the scene. In such a case, objects in the scene will typically be far from the camera position, and therefore there is a high chance that there will be many small primitives.

Shadow mapping is a depth-only rendering operation as described above, and therefore is particularly suitable to the operation of the technology described herein. In some embodiments, the method is a method of generating a shadow map.

In another embodiment, the render operation is a first processing pass which determines visibility of primitives to be processed, e.g. “in full”, in a second, subsequent processing pass. As such, in some embodiments, the method is a method of determining visibility of primitives to be processed in a subsequent processing pass.

However, it will be appreciated that the technology described herein may provide benefits in many other rendering operations, as desired.

As such, in some embodiments the enabling of storage of depth for primitives (e.g. for a draw call) may be enabled based on the expected content of the scene to be rendered. For example, when a scene to be rendered is expected to provide a large number of smaller primitives, the (potential) storage of depths for primitives for that draw call may be enabled.

Other criteria for determining whether the (potential) storage of depths in the manner of the technology described herein is enabled for a draw call may, of course, be used as desired.

Accordingly, in an embodiment generating binning data structures for identifying primitives to be processed for respective rendering tiles for a render output being generated comprises determining whether to store depths of sampling positions with respect to primitives for the render output, and when it is determined to store depths with respect to primitives for one or more primitives to be included in a binning data structure:
determining a depth of the primitive at one or more sampling positions that are covered by the primitive; and
including the determined depth or depths of the primitive in the binning data structure with respect to the primitive.

When it is determined not to store depths with respect to primitives, other data may be stored with respect to primitives to be included in data structures. The other data may be any suitable and desired data that can be stored with respect to primitives, for example and in embodiments vertex information for the primitives.

It would be possible that the storage of depths in the manner of the technology described herein is enabled only on a draw call basis, such that for a particular draw call, depths either are stored with respect to all primitives, or are not stored with respect to primitives at all, and in an embodiment that is what is done.

However, in embodiments, a determination as to whether to store a depth is made for one or primitives within render output, in an embodiment on a per-primitive basis. In embodiments, the per-primitive determination is made in addition to selectively enabling the (potential) storage of depths for primitives in general (such as on a per-draw call (render output) basis) as described above.

In such embodiments, a mixture of primitives where a depth is stored in the manner of the technology described herein and primitives where other data is stored with respect to the primitive may be included in binning data structures.

It would be possible to determine whether it is (actually) more efficient to store a depth with respect to a primitive in the manner of the technology described herein, or whether to store other data with respect to a primitive, and in an embodiment that is what is done.

As such, in embodiments, determining whether to store a depth for a primitive comprises determining the depth of the primitive at sampling positions covered by the primitive, and calculating the amount of memory required to store the determined depth(s). When the calculated amount of memory for storing depth with respect to the primitive is less than a threshold amount of memory, in an embodiment corresponding to the amount of data required to fetch vertex data for the primitive, a depth is included in the data structure with respect to the primitive.

In other embodiments, a property of the primitive may be used to determine whether or not to store depths for a primitive.

In this regard, the Applicants have identified that there are situations where a property of a primitive may provide an indication of whether it is more efficient to store a depth with respect to the primitive, or whether it is more efficient to store the primitives in another way (e.g. in the usual way for the graphics processor).

In an embodiment, the per-primitive determination is therefore made on the basis of a property of the primitive.

As such, in an embodiment, generating binning data structures for identifying primitives to be processed for respective rendering tiles comprises for one or more primitives to be included in a binning data structure (in an embodiment for which the storing of depths has been enabled): determining whether to store a depth with respect to the primitive based on a property of the primitive.

In particular, the Applicants have identified that in many situations there may be a mixture of larger and smaller primitives to be included in binning data structures. As described above, the storage of depths may be particularly beneficial for small primitives (e.g. that only cover a few sampling positions).

As such, in embodiments, the determination as to whether to store depths for a primitive may be made based on the size of the primitive.

The determination based on primitive size may be made in any suitable and desired way.

For example, and in an embodiment, the determination based on primitive size may be based on the number of sampling positions covered by the primitive.

When the primitive covers a number of sampling positions that is below a particular, in an embodiment selected, in an embodiment pre-determined, threshold number of sampling positions, the depth of the primitive at those covered sampling positions may be stored with respect to the primitive.

When the primitive covers more than the threshold number of sampling positions, depths at the sampling positions may not be stored with respect to the primitive, and (instead) other data may be stored with respect to the primitive (for example in the usual way for the graphics processor, for example by storing vertex information and/or bounding boxes with respect to the primitive).

Accordingly, in an embodiment, determining whether to store a depth with respect to a primitive based on a property of the primitive comprises determining the number of sampling positions covered by the primitive and, when the number of sampling positions is less than a threshold number of sampling positions, including a depth of the primitive at a (and in an embodiment each) covered sampling position in the binning data structure with respect to the primitive.

The threshold number of sampling positions may be any suitable number of sampling positions as desired, such as one, two, three, five or ten sampling positions. Other number of sampling positions are, of course, possible.

In this way, depths may be stored (only) with respect to small primitives, that only cover a small number of sampling positions, whilst larger primitives may be stored in the usual way for the graphics processor.

This may allow primitives of different sizes to be stored efficiently. Particularly, for small primitives, a depth may be stored in, and subsequently directly read from, binning data structures, whilst for larger primitives (where fetching co-ordinates of each vertex may require fetching less data than fetching a depth for each sampling position covered by the primitive), depths can be (and are in embodiments) calculated later (e.g. when using the binning data structures to render a rendering tile) from fetched vertex position information. In each case therefore, data can be stored with respect to the primitive that can be fetched in a bandwidth efficient manner.

In some embodiments, the determination based on primitive size may be based on an area of the primitive.

The primitive area may be calculated in any suitable and desired way. For example, a (in embodiments projected) area of the primitive may be calculated from (transformed) vertex positions and used in the determination.

In embodiments, when the primitive has an area below a particular, in an embodiment pre-determined, threshold value, depths may be stored with respect to the primitive. When the primitive has an area greater than the threshold value, depths may (and in embodiments are) not be stored with respect to the primitive, and (instead) other data may be stored with respect to the primitive (for example in the usual way for the graphics processor, for example by storing vertex information and/or bounding boxes with respect to the primitive).

In this regard, the Applicants have identified that the primitive area may provide an estimate for the number of sampling positions covered by a primitive, and therefore may allow (large) primitives where storing depths may less beneficial to be identified easily, and processed accordingly (for example in a usual manner for the graphics processor), without needing to determine sampling positions covered by the a primitive (and so allows large primitives to be excluded with reduced processing).

Accordingly, in an embodiment, determining whether to store a depth with respect to a primitive based on a property of the primitive comprises determining an area of the primitive and, when the area is less than a threshold area, including a depth in the binning data structure with respect to the primitive.

In an embodiment, determining whether to store a depth with respect to a primitive based on a property of the primitive comprises a first determination made based on the primitive area, and a second determination based on the number of sampling positions covered.

In this way, the determination based on primitive area may filter out very large primitives without needing to determine sample coverage, whilst the second determination based on the number of sampling positions covered may provide a finer-grained selection of whether to identify primitives by including depths such that primitives can be stored such that they can be fetched in the most bandwidth efficient manner.

It will be appreciated that such a determination based on a property of the primitive (e.g. using primitive area and/or number of sampling positions covered) may be made instead of selectively enabling the storing of depths with respect to plural primitives (e.g. for draw calls) as described above. However, in an embodiment, the determination based on primitive size is a further determination, made in addition to the selective enablement of the (potential) storage of depths for a render output (e.g. draw call) as a whole.

As such, in embodiments, generating a binning data structure for identifying primitives to be processed for a rendering tile comprises determining, for one or more primitives (e.g. for a draw call), whether to (potentially) store a depth with respect to the one or more primitives, and for one or more primitives for which it has been determined to (potentially) store a depth including one or more primitives in the binning data structure comprises determining whether to store a depth with respect to the primitive based on a property of the primitive.

When storing depths in the manner of the technology described herein, for one or more primitives to be included in a binning data structure a depth of the primitive at (in an embodiment each of) one or more sampling positions that are covered by the primitive is determined and included in the binning data structure with respect to the primitive.

The sampling positions that are covered by a primitive can be determined in any suitable and desired way, such as in the usual way for the graphics processor. For example, the primitive may be rasterised, to determine which (if any) sampling positions are covered by the primitive.

In some embodiments, the determination of sampling positions covered by the primitive may be “exact” (i.e. based on the exact dimensions of the primitive). In other embodiments, the determination of sampling positions covered by the primitive is conservative (i.e. an area including, but larger than, the primitive is used to determine sampling positions covered by the primitive).

Once sampling positions covered by a primitive have been determined, the depth of the primitive at a (and in an embodiment each) sampling position covered by the primitive is determined. The depth of the primitive at a (each) sampling position may be determined in any suitable and desired way, such as in the usual way for the graphics processor. For example, and in embodiments, the depth is calculated from vertex position data for the primitive.

In accordance with the technology described herein, the determined depth for the covered sampling position(s) is then stored in the binning data structure with respect to the primitive.

The determined depth of the primitive can be stored in any suitable and desired way. In an embodiment, along with a depth of the primitive for the sampling position, an indication of which sampling position the depth is refers to is (also) stored in the binning data structure, such that including a determined depth of the primitive in the binning data structure with respect to the primitive comprises storing (both) the determined depth and an indication of the sampling position to which the depth corresponds in the binning data structure.

The indication of which sampling position the depth corresponds to may be stored in any suitable way. In some embodiments, a sample ID indicating a position of the sampling position in the array of sampling positions may be stored along with the depth.

In embodiments, the indication of which sampling position the depth corresponds to (e.g. sample ID) indicates the position of the sampling position within the region (area) of the render output to which the binning data structure corresponds. For example, in embodiments where the binning data structure comprises primitive lists, within the region of the render output for which the primitive list has been prepared. In embodiments where the binning data structure comprises one or more bounding boxes, the sample ID may indicate a position of the sampling position within a or the bounding boxes.

In some embodiments, the indication of which sampling position the depth corresponds to comprises an indication of a position of a pixel (in embodiments within the region (area) of the render output to which the binning data structure corresponds), and an indication of a sample position within the pixel.

Other options are, of course, possible as desired.

It will be appreciated from the above that, in the operation of the technology described herein, when including primitives in binning data structures, depth values of covered sampling positions are stored with respect to at least some primitives.

In some embodiments, vertex information is stored with respect to primitives included in the binning data structure. In some embodiments, vertex information is stored (only) with respect to primitives for which a depth is not stored.

In other embodiments, vertex information is stored with respect to all primitives included in binning data structures, in addition to storing depths of covered sampling positions with respect to some or all primitives. This may be particularly beneficial when performing an e.g. initial processing pass to determine primitives that are visible, which can then be “fully” processed in a subsequent processing pass. In such a case, the depth information (where available) may be used when determining primitives that are visible, and the vertex information may be used when performing the “full” processing pass.

Any other suitable (further) information may be stored in the binning data structure with respect to primitives as desired. For example, and in an embodiment, a primitive ID is stored with respect to a (each) primitive.

Once the binning data structures have been generated, they can be (and are in an embodiment) stored (for example in memory) for use when identifying primitives to be processed for rendering tiles. The binning data structures can be stored in any suitable and desired way, such as in the usual way for the graphics processor.

In some embodiments, the depths included in the binning data structure are compressed. As such, in an embodiment, generating a binning data structure for identifying primitives to be processed for a rendering tile may comprise compressing the determined depths. The compression may be any suitable and desired compression, for example, and in an embodiment, delta compression.

In this regard, the Applicants have identified that, when storing depths with respect to primitives, many of the depths stored will be similar to other depths that are stored.

In particular, the depths of different sampling positions for the same primitive are highly likely to be highly similar, as are depths of sampling positions for different primitives associated with the same object within a scene. As such, compression of the depths may provide significant reduction in the size of the binning data structures, and so provide further reductions in required bandwidth.

Once binning data structures have been generated, the binning data structures are then used when rendering tiles of the render output to determine primitives to be processed for respective rendering tiles.

Generally, using binning data structure(s) to identify primitives to be processed for a rendering tile comprises reading the binning data structure(s) (e.g. from memory), using the binning data structure when identifying primitives to be processed for rendering tiles, and then performing subsequent processing on the primitives to generate (respective tiles of) a render output.

The subsequent processing may be, and is in an embodiment, performed on a tile-by-tile basis (with each tile corresponding to a respective sub-region of the render output being processed separately (e.g. in turn)). The processing performed on a tile-by-tile basis may comprise any suitable and desired processing for rendering a tile of a render output, e.g. triangle setup, rasterising, depth culling, rendering (e.g. fragment shading and/or ray-tracing), etc.

In particular, in tile-based rendering, the subsequent processing may normally comprise triangle setup and rasterization, where (transformed) vertex positions of the primitive are determined (either fetched from memory or calculated from object-space positions), and then used, amongst other things, to determine sampling positions covered by a primitive, along with the depths of the primitive at the covered sampling positions thereof.

However, in the operation in the manner of the technology described herein, for one or more primitives to be processed for a rendering tile for a render output being generated, depths at sample positions covered by primitives are determined and included in the binning data structure with respect to the primitives.

As such, instead of performing primitive setup and rasterization of such primitives to calculate depth of sampling positions, the depth(s) with respect to a primitive can be, and are in an embodiment, read (directly) from the binning data structure with respect to the primitive.

Once the depth has been read from the binning data structure, (further) subsequent processing for the graphics processing pipeline can be (and is) performed. The (further) subsequent processing can be any suitable and desired processing for generating a render output, such as depth culling, rendering (e.g. fragment shading and/or ray-tracing), etc.

For example, and in an embodiment, when a depth has been stored with respect a primitive, the depth value may be used for performing an early-Z test for the primitive, and then the processing of the primitive (and rendering tile) may be continued in any suitable and desired way, such as in the usual way for the graphics processor.

The depths can be read and used for the subsequent processing in any suitable and desired way.

For example, and in embodiments, the determined depths are used to (directly) generate appropriate fragments for sampling positions for which depths have been determined, which can be, and in embodiments are, then processed in the usual way for the graphics processor.

In some embodiments, as described above, the binning data structures may comprise other data with respect to primitives (as well as depths), for example vertex information or non-position information. In some such embodiments, the determined depths may be used for at least some subsequent stages of the graphics processing pipeline (for example to perform a culling operation such as hidden surface removal), whilst the other data stored with respect to the primitive may be used for (other) subsequent stages of the graphics processing pipeline (for example to allow colour to be calculated).

As described above, in some embodiments, the render operation is a first render pass which determines visibility of primitives to be processed. In such embodiments, the subsequent processing may comprise using the determined depths to determine which primitives are visible for the rendering tile. (Only) these primitives determined to be visible may be, and in embodiments are, used in a subsequent rendering operation to generate a desired output, e.g. frame to be displayed.

In such embodiments, when including primitives in binning data structures, vertex information is in an embodiment stored for each primitive included in the binning data structure (along with depths for at least some primitives). The binning data structures generated during the first rendering operation may also be, and are in embodiments, used in the subsequent rendering operation, e.g. in the normal way for the graphics processor.

In this way, by storing depths of covered sample positions with respect to at least some primitives, the first (e.g. initial) rendering pass may be performed quickly using the determined depths, whilst the subsequent processing pass may be performed in the usual way for the graphics processor, e.g. without having to re-determine new binning data structures.

Accordingly, in some embodiments, rendering respective tiles of the render output may comprise:
determining primitives that are visible for a rendering tile using the binning data structures; and
subsequently, processing primitives that are determined to be visible to render the rendering tile.

In an embodiment, determining primitives that are visible for a rendering tile using the binning structures comprises using the determined depth or depths for one or more primitives.

In an embodiment, processing primitives that are determined to be visible to render the rendering tile comprises using the binning data structures. In an embodiment, processing primitives that are determined to be visible to render the rendering tile comprises using vertex information from the binning data structures.

In some embodiments, as described above, a depth is not stored with respect to all primitives. Instead, whilst a depth is stored for some primitives, other data, e.g. vertex information, is stored with respect to other primitives.

As described above, in at least some embodiments, the storage of depths in the manner of the technology described herein is selectively enabled, and/or depths are not stored with respect to all primitives to be processed for a render output (e.g. depths may not be stored with respect to large primitives).

As such, when reading and using binning data structures to identify primitives to be processed for rendering tiles, the binning data structures may comprise primitives where depths are stored in the manner of the technology described herein, and/or primitives stored in another, e.g. “normal”, manner.

The graphics processor therefore should be, and is in an embodiment, operable to process both primitives for which a depth has been stored in the manner of the technology described herein, and primitives for which no depth has been stored.

As such, when using a binning data structure to identify primitives to be processed for a rendering tile, it may be, and is in embodiments, necessary to determine whether a depth or depths have been stored (and so whether the primitive needs to be rasterised to determine sampling positions covered by the primitive), and then processing the stored data appropriately.

In some embodiments where the storage of depths in the manner of the technology described herein is selectively enabled, for example on a render-output by render-output basis (e.g. per draw call), the determination as to whether depths have been stored can be (and is in embodiments) made on whether the storage of depths is enabled (for example whether it is enabled with respect to the draw call in question). When it is determined that the storage of depths has not been enabled, the data structures may be read and used in any suitable and desired way, such as in the usual way for the graphics processor.

Furthermore, as described above, in some embodiments, whether or not depth is stored for primitives may be determined on a finer (e.g. per primitive) basis. As such, in some embodiments, when a primitive is identified by the binning data structure to be processed for a rendering tile of a render output, it is then determined whether a depth has been stored with respect to the primitive.

The determination of whether a depth has been stored with respect to a primitive can be made in any suitable and desired way.

For example, and in an embodiment, the determination can be made on the basis of a property of the data stored with respect to the primitive.

In one embodiment, the determination is made based on the amount of data fetched with respect to the primitive when using the binning data structure to identify primitives to be processed. For example, and in embodiments, storing depths in the manner of the technology described herein may mean that less data is fetched with respect to the primitive than if the primitives are represented in binning data structures in a conventional manner.

In other embodiments, an indication may be stored with respect to one or more (and in an embodiment with respect to each) primitive in a binning data structure to indicate whether a depth has been stored with respect to the one or more primitives. The indication may be any suitable and desired such indication, for example, and in an embodiment, a control bit.

In some embodiments, a primitive encoding type indicator is stored with respect to a (and in embodiments each) primitive stored in a binning data structure, the primitive encoding type indicator defining the format in which the primitive is included in the binning data structure. In embodiments, the storage of depths for a primitive is indicated by, and determined on the basis of, the inclusion of an appropriate primitive encoding type indicator with respect to the primitive.

As described above, in some embodiments, the storage of depth can both be selectively enabled both on an overall (e.g. per draw-call) and a finer (e.g. per primitive) basis.

In such embodiments, it would be possible to determine whether a depth has been stored of each primitive (independently of whether the storage of depths has been enabled overall, e.g. for the draw call), and in an embodiment that is what is done.

However, in an embodiment, the determinations of whether depths have been stored with respect to (individual) primitives are only made when the storage of depths in the manner of the technology described herein has been enabled overall (e.g. for the draw call).

Other arrangements are, of course, possible as desired.

When it is determined that a depth has not been stored with respect to a primitive to be processed and/or when the storage of depths has not been enabled, primitives may be processed in any suitable and desired way to generate a render output, such as in the usual way for the graphics processor. For example, vertex positions may be fetched, position shaded, and then rasterised to determine sample positions covered by the primitive and the depths thereof.

Accordingly, in an embodiment, rendering a tile of a render output by using a binning data structure to determine primitives to be processed for the rendering tile comprises:
using the binning data structure to identify primitives to be processed for the rendering tile;
determining whether a depth has been stored with respect to a primitive identified to be processed; and
when a depth has been stored with respect to a primitive, using the stored depth when rendering the rendering tile.

In an embodiment, when a depth has not been stored with respect to a primitive, rendering a tile of a render output by using a binning data structure to determine primitives to be processed for the rendering tile comprises determining which sampling positions are covered by the primitive, calculating the depth of the primitive at sampling positions covered by the primitive, and using the calculated depths of the primitive at the sampling positions when rendering the rendering tile.

The technology described herein extends to such rendering of rendering tiles.

Accordingly, an embodiment of the technology described herein comprises a method of operating a graphics processor when rendering a rendering tile of a render output by using a binning data structure to identify primitives to be processed for the rendering tile, in which the graphics processor is operable to, for one or more primitives to be included in a binning data structure, store a depth or depths of a primitive at one or more sampling positions covered by the primitive in the binning data structure with respect to the primitive, the method comprising:
using the binning data structure to identify primitives to be processed for the rendering tile; and
for one or more primitives identified to be processed for the rendering tile for which a depth has been included in the data structure with respect to the primitive:
   reading a depth from the binning data structure with respect to the primitive, and
   using the read depth when rendering the rendering tile.

Another embodiment of the technology described herein comprises a graphics processor operable to perform tile-based renders, in which a rendering tile of a render output is rendered by using a binning data structure to identify primitives to be processed for rendering tiles, the graphics processor operable to, for one or more primitives to be included in a binning data structure, store a depth or depths of a primitive at one or more sampling positions covered by the primitive in the binning data structure with respect to the primitive, the graphics processor comprising:
a primitive identification circuit configured to use the binning data structure to identify primitives to be processed for the rendering tile; and
a rendering circuit configured to, for one or more primitives identified to be processed for the rendering tile for which a depth has been stored with respect to the primitive:
   read a depth from the binning data structure with respect to the primitive, and
   use the read depth when rendering the rendering tile.

As will be appreciated by those skilled in the art, these embodiments of the technology described herein may, and in embodiments do, comprise any one or more or all of the features of the technology described herein, as appropriate.

The above describes the main elements and operation of the graphics processor and graphics processing pipeline that are relevant to operation in the manner of the technology described herein.

As will be appreciated by those skilled in the art, the graphics processor can otherwise include and execute, and in an embodiment does include and execute, any one or one or more, and in an embodiment all, of the processing stages and circuits that graphics processors and graphics processing pipelines may (normally) include.

In an embodiment, the graphics processor comprises, and/or is in communication with a memory system, one or more memories, and/or memory devices that store the data described herein, and/or that store software for performing the processes described herein. The graphics processor may also be in communication with a host microprocessor, and/or with a display for displaying images based on the output of the graphics processor.

The output to be generated may comprise any output that can and is to be generated by the graphics processor and processing pipeline. Thus it may comprise, for example, a frame of output fragment data. The technology described herein can be used for all forms of output that a graphics processor and processing pipeline may be used to generate, such as frames for display, render-to-texture outputs, etc. In an embodiment, the output is an output frame, and in an embodiment an image. In an embodiment, the output is a shadow map.

In an embodiment, the various functions of the technology described herein are carried out on a single graphics processing platform that generates and outputs the (rendered) data that is, e.g., written to a frame buffer for a display device.

The various functions of the technology described herein can be carried out in any desired and suitable manner. For example, unless otherwise indicated, the functions of the technology described herein can be implemented in hardware or software, as desired. Thus, for example, unless otherwise indicated, the various functional elements, stages, and “means” of the technology described herein may comprise a suitable processor or processors, controller or controllers, functional units, circuitry, circuits, processing logic, microprocessor arrangements, etc., that are configured to perform the various functions, etc., such as appropriately dedicated hardware elements (processing circuits/circuitry) and/or programmable hardware elements (processing circuits/circuitry) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuitry/circuits, etc., if desired.

Furthermore, unless otherwise indicated, any one or more or all of the processing stages of the technology described herein may be embodied as processing stage circuits, e.g., in the form of one or more fixed-function units (hardware) (processing circuits), and/or in the form of programmable processing circuits that can be programmed to perform the desired operation. Equally, any one or more of the processing stages and processing stage circuitry of the technology described herein may be provided as a separate circuit element to any one or more of the other processing stages or processing stage circuits, and/or any one or more or all of the processing stages and processing stage circuits may be at least partially formed of shared processing circuits.

Subject to any hardware necessary to carry out the specific functions discussed above, the graphics processor can otherwise include any one or more or all of the usual functional units, etc., that graphics processors include.

It will also be appreciated by those skilled in the art that all of the described embodiments of the technology described herein can, and, in an embodiment, do, include, as appropriate, any one or more or all of the features described herein.

The methods in accordance with the technology described herein may be implemented at least partially using software e.g. computer programs. It will thus be seen that the technology described herein may provide computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc.

The technology described herein also extends to a computer software carrier comprising such software which when used to operate a display controller, or microprocessor system comprising a data processor causes in conjunction with said data processor said controller or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus, in a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible, non-transitory medium, such as a computer readable medium, for example, diskette, CDROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrinkwrapped software, preloaded with a computer system, for example, on a system ROM or fixed disk, or distributed from a server or electronic bulletin board over a network, for example, the Internet or World Wide Web.

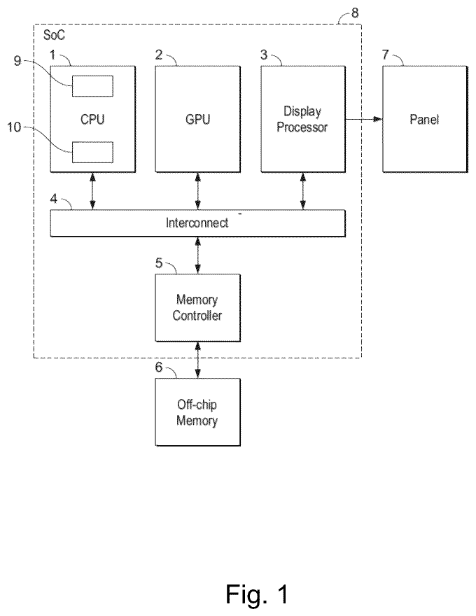

FIG. 1 shows an exemplary system on chip (SoC) graphics processing system 8 that comprises a host processor comprising a central processing unit (CPU) 1, a graphics processor (GPU) 2, a display processor 3, and a memory controller 5. As shown in FIG. 1, these units communicate via an interconnect 4 and have access to off-chip memory 6. In this system, the graphics processor 2 will render frames (images) to be displayed, and the display processor 3 will then provide the frames to a display panel 7 for display.

In use of this system, an application 9 such as a game, executing on one or more host processors (CPUs) 1 will, for example, require the display of frames on the display panel 7. To do this, the application will submit appropriate commands and data to a driver 10 for the graphics processor 2, e.g. that is executing on a CPU 1. The driver 10 will then generate appropriate commands and data to cause the graphics processor 2 to render appropriate frames for display and to store those frames in appropriate frame buffers, e.g. in the main memory 6. The display processor 3 will then read those frames into a buffer for the display from where they are then read out and displayed on the display panel 7 of the display.

In the present embodiment, the graphics processor 2 executes a graphics processing pipeline that processes graphics primitives, such as triangles, when generating an output, such as an image for display.

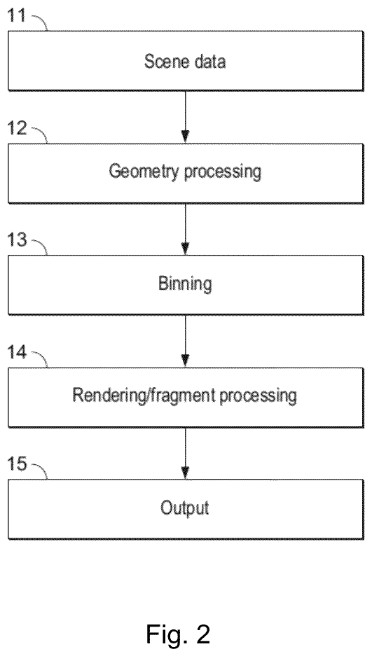

FIG. 2 shows schematically the processing sequence of the graphics processing pipeline executed by the graphics processor 2 when generating an output in the present embodiments.

FIG. 2 shows the main elements and pipeline stages. As will be appreciated by those skilled in the art there may be other elements of the graphics processor and processing pipeline that are not illustrated in FIG. 2. It should also be noted here that FIG. 2 is only schematic, and that, for example, in practice the shown pipeline stages may share significant hardware circuits, even though they are shown schematically as separate stages in FIG. 2. It will also be appreciated that each of the stages, elements and units, etc., of the processing pipeline as shown in FIG. 2 may, unless otherwise indicated, be implemented as desired and will accordingly comprise, e.g., appropriate circuitry, circuits and/or processing logic, etc., for performing the necessary operation and functions.

As shown in FIG. 2, for an output to be generated, a set of, e.g. scene data 11, including, for example, and inter alia, a set of vertices (with each vertex having one or more attributes, such as positions, colours, etc., associated with it), a set of indices referencing the vertices in the set of vertices, and primitive configuration information indicating how the vertex indices are to be assembled into primitives for processing when generating the output, is provided to the graphics processor, for example, and in an embodiment, by storing it in the memory 6 from where it can then be read by the graphics processor 2.

This scene data may be provided by the application (and/or the driver in response to commands from the application) that requires the output to be generated, and may, for example, comprise the complete set of vertices, indices, etc., for the output in question, or, e.g., respective different sets of vertices, sets of indices, etc., e.g. for respective draw calls to be processed for the output in question. Other arrangements would, of course, be possible.

There is then a geometry processing stage or stages 12, which performs appropriate geometry processing of and for the scene data to generate the data that will then be required for rendering the output. This geometry processing 12 can comprise any suitable and desired geometry processing that may be performed as part of a graphics processing pipeline.

In the present embodiments, this geometry processing comprises at least performing vertex processing (vertex shading) of attributes for vertices to be used for primitives for the render output being generated. In particular, appropriate vertex position shading is performed to transform the positions for the vertices from the, e.g. “model” space in which they are initially defined, to the, e.g., “screen”, space that the output is being generated in. In embodiments, the vertex shading also comprises generating and/or processing other, non-position attributes of vertices. It would also be possible for some or all the varying shading to be deferred from the geometry processing and, for example, to be triggered at the binning or rendering stages instead, if desired.

As well as appropriate vertex shading, the geometry processing may comprise any other form of geometry processing that is desired, such as one or more of tessellation shading, transform feedback shading, mesh shading, or task shading. This geometry shading may also generate and/or process attributes for vertices, and/or it may process and generate attributes for primitives as well.

Once the desired geometry processing has been performed, there is then, in the present embodiments, as shown in FIG. 2, a binning/tiling stage 13.

The binning process operates to generate appropriate data structures for determining which primitives need to be processed for respective rendering tiles of the output being generated. For example, it may sort the primitives into appropriate primitive lists, which indicate the primitives to be processed for respective tiles or sets of tiles. Alternatively, it may generate other data structures, such as hierarchies of bounding boxes, that can then be used at the rendering/fragment processing stage to identify those primitives that need to be processed for a respective tile.

The binning/tiling process 13 may also cull primitives that are not visible (e.g. that fall outside the view frustum, and/or based on the facing direction of the primitives).

As part of the geometry processing and/or the binning/tiling operation the primitives to be processed will be “assembled”. The primitives will, as discussed above, be assembled from a set of indices referencing vertices in a set of vertices for the render output processing being performed, based on primitive configuration information indicating how the vertex indices are to be assembled into primitives for processing when generating the render output.

Such primitive assembly may be performed as part of and at an appropriate stage of the geometry processing and/or as part of the binning/tiling processing, as desired. There may also, if desired, be two (or more) “primitive assembly” operations. For example, an initial primitive assembly operation could be performed to identify those vertices that will actually be used for the render output being generated before performing any vertex shading of the vertices, but with there then being a later primitive assembly stage that provides a sequence of assembled primitives for the binning/tiling stage.

Once the binning/tiling process has generated the necessary data structures for identifying the primitives to be processed for respective tiles of the render output, the primitives can then be and are then subjected to appropriate rendering/fragment processing 14. This operation is performed in the present embodiments on a tile-by-tile basis, using the data structures generated by the tiling/binning process 13 to identify those primitives that need to be processed for a respective tile.

The rendering/fragment processing can comprise any suitable and desired rendering and fragment processing operations that may be performed. Thus it may comprise, for example, first rasterising primitives to be processed for a tile to fragments, and then processing those fragments accordingly (e.g., and in an embodiment, by performing appropriate fragment shading of the fragments). The rendering/fragment processing may also or instead comprise performing ray tracing operations, such as performing the rendering by tracing rays for respective fragments representing respective sets of one or more sampling positions of the output being generated. Hybrid ray tracing operations would also be possible, if desired.

The output of the rendering/fragment processing (the rendered fragments) is written to a tile buffer (not shown). Once the processing for the tile in question has been completed, then the tile will be written to an output data array in memory 6, and the next tile processed, and so on, until the complete output data array 15 has been generated. The process will then move on to the next output data array (e.g. frame), and so on.

The output data array may typically be an image for a frame intended for display on a display device, such as a screen or printer, but may also, for example, comprise intermediate render data intended for use in later rendering passes (also known as a “render to texture” output), or for deferred rendering, or for hybrid ray tracing, etc.

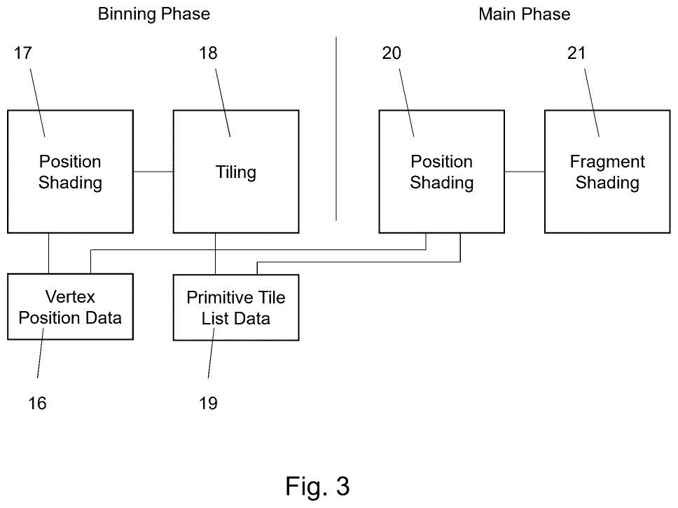

FIG. 3 shows schematically an exemplary tile-based graphics processing pipeline, which may perform the processing sequence of FIG. 2.

In the graphics processing pipeline of FIG. 3, in a first (binning) phase, vertex position data 16 is fetched, for example from memory 6. The vertex position data 16 is then used for position shading 17, to transform the positions for the vertices from the, e.g. “model” space in which they are initially defined, to the, e.g., “screen”, space that the output is being generated in.

This (transformed) vertex data is then used for tiling 18. The tiling 18 uses the transformed vertex data to generate binning data structures for identifying primitives to be processed for rendering tiles.

In the exemplary graphics processing pipeline of FIG. 3, the transformed vertex data is used to sort primitives into appropriate primitive tile lists indicating the primitives to be processed for respective tiles or sets of tiles, and therefore the binning data structure is in the form of a primitive tile list. Primitive tile list data 19 is stored, e.g. in memory, for the primitive tile lists. This primitive tile list data 19 includes information indicating the primitives to be processed for respective tiles or sets of tiles, and includes vertex information (e.g. in the form of a vertex index) that allows the vertices of the included primitives to be identified.

However, the tiling 18 could instead perform another sort of binning as appropriate, for example generating hierarchies of bounding boxes, that can then be used at the rendering/fragment processing stage to identify those primitives that need to be processed for a respective tile.

The binning phase is followed by a “main” phase, in which respective rendering tiles of the render output are rendered to generate an overall render output.

In the main phase, the binning data structures (in this example, primitive tile list data 19) are read to identify primitives to be processed for respective rendering tiles of the render output being generated. Particularly, vertex information (e.g. vertex indices) is used to identify vertices that must be fetched for the primitives to be processed. The vertex position data 16 is then fetched accordingly (e.g. from memory 6) and used for (further) position shading 20. This generates transformed vertex data for a primitive (and primitives) that may then be rasterised to determine fragments to be processed for the primitives.

The fragments then undergo appropriate fragment shading 21, to generate the render output.

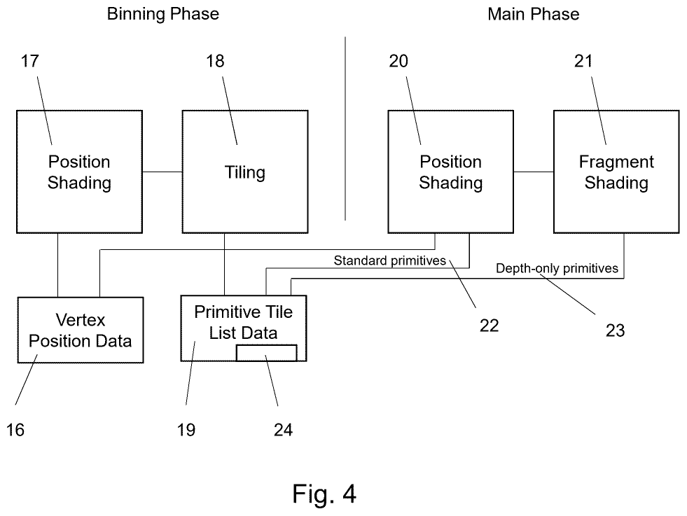

FIG. 4 shows schematically another graphics processing pipeline in accordance with an embodiment, which may perform the processing sequence of FIG. 2.

In the graphics processing pipeline of FIG. 4, vertex position data 16 is again fetched (e.g. from memory 6), and position shaded 17. The position shaded data is then used for tiling 18 to determine appropriate binning data structures for use in the main phase.

However, in the graphics processing pipeline of FIG. 4, the tiling 18 stage is operable to store a depth or depths of a (and each) primitive to be included in a data structure at (each of) one or more sampling positions covered by the primitive. In the present embodiment, when a depth is included in a binning data structure with respect to a primitive, vertex information (for example a vertex ID) is not included with respect to the primitive. However, in other embodiments, depths may be included in binning data structures with respect to a primitive in addition to vertex information for the primitive.

As such, the primitive tile list data 19 may include depths 24 with respect to at least some primitives and/or other data (for example vertex information) for primitives for which a depth is not stored.

In the main phase, the primitive tile list data 19 is read to identify primitives to process for a rendering tile.

For any “standard” primitives 22 for which a depth is not stored, vertex information in the primitive tile list 19 is used to identify and fetch vertex position data 16, which is position shaded 20 and fragment shaded 21 as described with respect to FIG. 3.

However, for “depth-only” primitives 23 where a depth 24 has been stored with respect to a primitive, the depth 24 is used (directly) for fragment shading 21. As such, the amount of processing (and therefore latency) during the main phase is reduced.

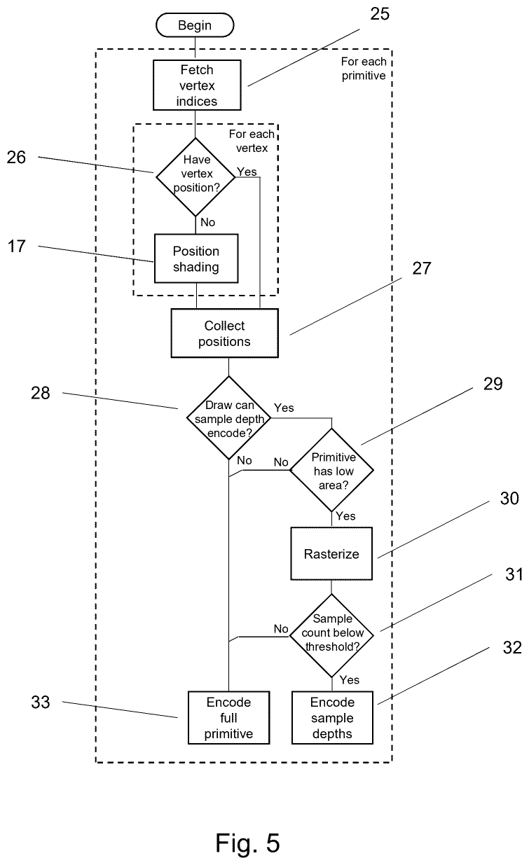

FIG. 5 shows schematically the generation of data structures in an operation according to an embodiment.

For a (and each) primitive to be included in a data structure, vertex indices are fetched 25 (for example from memory 6), indicating the vertices that are to be processed for the primitive.

For each vertex, it is then determined 26 whether a (transformed) vertex position (e.g. in the “screen” space that the output is being generated in) has already been calculated for the vertex. If so, the already calculated vertex position is collected 27 (e.g. fetched from memory 6) for use with the primitive.

If a transformed vertex position has not already been calculated for the vertex, the vertex is position shaded 17 to produce a transformed (e.g. “screen” space) position for the vertex, which is then collected 27 for use with the primitive.

Once the vertex positions have been collected 27, the primitive is then included in a data structure.

In the present embodiment, the (potential) storage of depths for sampling positions with respect to primitives to be included in binning data structures is selectively enabled on a per-draw call basis. In the present embodiments, the (potential) storage of depths is selectively enabled by the driver 10, e.g. in response to an application 9 being run, but the (potential) storage of depths may be selectively enabled in other ways as desired.

As such, for each primitive to be included in a data structure, it is first determined 28 whether the (potential) storage of depths is enabled for the current draw call.

In the present embodiments, if the (potential) storage of depth is enabled for the current draw call, properties of the primitive are then used to determine whether to (actually) store a depth for primitive being processed. This allows the primitive to be included in binning data structures in a bandwidth efficient manner.

In particular, whilst storing depths will reduce the processing required during a main stage of the graphics processing pipeline, as described above, the storage of depths for primitives may be particularly beneficial for small primitives, that only cover a small number of sampling positions.

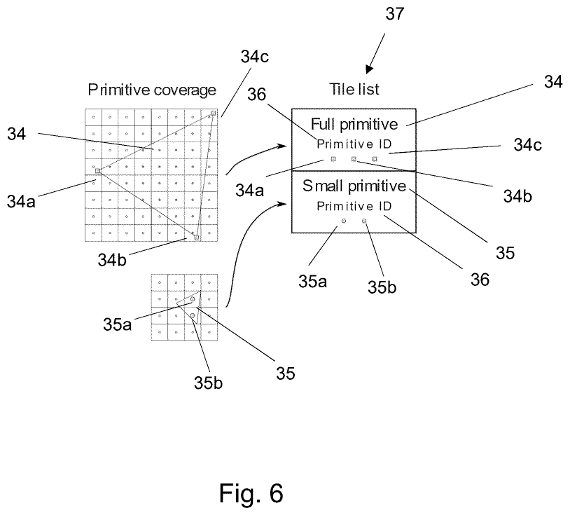

FIG. 6 illustrates the storage of two primitives in the operation of embodiments of the technology described herein.

For a small primitive 35 that covers a small number (two) sampling positions, a depth of the primitive at each of the two sampling positions (35a, 35b) is included in the binning data structure 37 with respect to the primitive 35.

Each sample depth may be stored as a 32 bit-floating point value for the depth along with a 12-bit sample ID (which identifies which sampling point (e.g. within a region to which the binning data structure corresponds, such as the tile in question) the depth refers to). As such, fetching the data requires 88 bits of data.

In contrast, if the full vertex positions for the primitive are fetched, then these require a 32-bit value for each (three-dimensional) co-ordinate of each vertex, and so require 288 bits of data to fetch. Accordingly, the storage of depths in the manner of the operation of the technology described herein reduces the bandwidth required for small primitives.

However, in the present embodiment, for a larger primitive 34 that covers a large number of sampling points, depths of the primitive at the sampling positions are not stored, and other data is stored with respect to the primitive. In the present embodiments, vertex indices are included in the primitive list for each vertex (34a, 34b, 34c) of the primitive, to allow vertex positions to be fetched (and used to calculate depth of the sampling positions in the main phase when necessary). In this case, fetching a depth for each sampling position covered by the primitive may require fetching more data than fetching the vertex positions and (re)calculating the depth, and so the storage of vertex indices with respect to the primitive may be more efficient. As such, by storing depths with respect to smaller primitives, and vertex indices with respect to larger primitives, primitives can be stored in binning data structures in the most bandwidth efficient way.

Accordingly, with reference to FIG. 5, once it has been determined 28 that the storage of depths is enabled for the current draw call, the area of the primitive is calculated 29. If the area of the primitive is higher than a pre-determined threshold, then the primitive is determined to be large, and no depth is stored with respect to the primitive. In this respect, the determination of the area of the primitive provides an indication of whether or not the primitive covers a large number of sampling positions, and so whether it is likely to be suitable for storing depth, without requiring significant extra processing.

However, if the area is below the threshold, the primitive is determined to be small, and the primitive is rasterised 30 to determine any sampling points covered by the primitive, and the depth of the primitive at the sampling points calculated.

It is then determined whether the primitive covers fewer than a pre-determined threshold number of sampling positions 31. If it is determined that the primitive covers fewer than a pre-determined threshold number of sampling positions, then the determined depths are stored with respect to the primitive 32.

If the primitive does not cover any sampling positions, then it may be culled (such that no data is included in the binning data structure with respect to the primitive).

If at any point it is determined not to store a depth with respect to the primitive (for example if storage of primitives is not enabled for the draw call, or if the primitive is larger than the threshold area or covers more than the threshold number of sampling positions), then the “full” primitive is encoded 33, for example by including vertex indices for the primitive in the binning data structure with respect to the primitive.

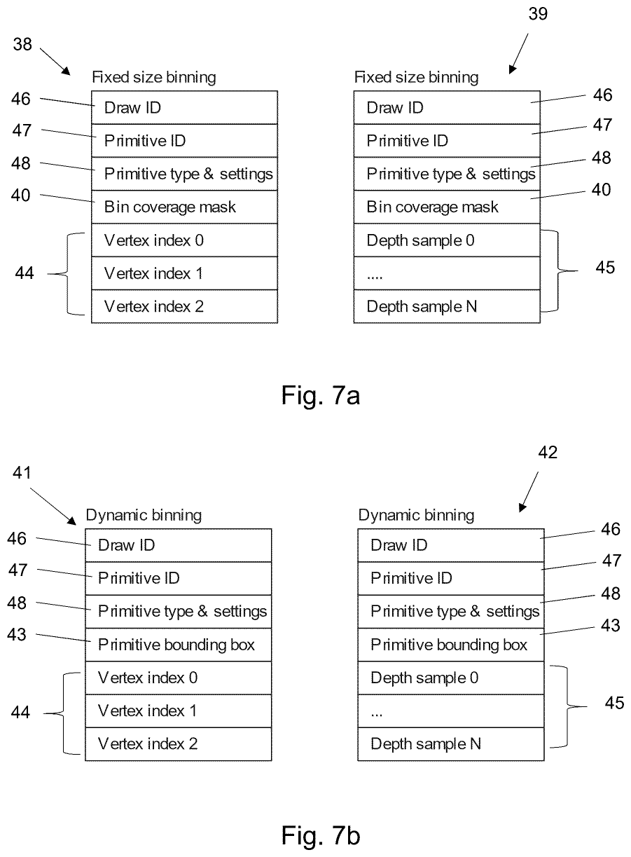

FIG. 7 shows a part of the binning data structures for use in the operation of the technology described herein.

As described above, the binning data structures may be lists of primitives to be processed for a particular region of the render output (so called “primitive” or “tile” lists), or may comprise a hierarchy of bounding boxes that can be compared to a region of a render output to be processed.

FIG. 7a shows the data included a binning data structure for a primitive in an embodiment where the binning data structures (38, 39) comprise tile lists. As such, the binning data structures (38, 39) includes a bin coverage mask 40, indicating which region of the render output the binning data structure (38, 39) lists primitives for.

FIG. 7b shows the data included a binning data structure for a primitive in another embodiment, where the binning data structures (41, 42), comprise bounding boxes. In this embodiment, the bounding boxes at least include a primitive bounding box 43, which can be compared to a region (e.g. tile) of the render output being processed to determine whether the primitive is to be processed for the rendering tile. In an embodiment, the primitive bounding box 43 forms part of a hierarchy of bounding boxes that allows the primitives to be processed for a region of the render output to be determined.

In the present embodiment, the graphics processor is operable to either encode “full” primitives 33 or encode depths of sampling positions with respect to primitives 32.

When encoding “full” primitives 33, a vertex index 44 for each vertex of the primitive is included in the binning data structure (38, 40) with respect to the primitive.

When encoding depths 32, depth samples 45 (both the depth of the primitive at a sampling position, and an indication of which sampling position the depth refers to) are included in the binning data structure (39, 41) for each sampling position covered by the primitive.

Whilst the vertex indices 44 and depth samples 45 in FIG. 7 are shown in two different binning data structures, it will be appreciated that any particular binning data structure may include primitives stored in either or in both ways. Furthermore, in some embodiments both vertex indices 44 and depth samples 45 may be stored with respect to the same primitive.

In each of the binning data structures (38, 39, 40, 41) of FIG. 7, further data is stored with respect to primitives. This includes a primitive ID 47, which identifies the primitive that the vertex/depth data corresponds to, a draw ID 46, which indicates which draw call the primitive relates to, and further data regarding the type and settings 48 for the primitive.

Whilst these are shown in each data structure (38, 39, 40, 41), it will be appreciated that the (additional) data included in the binning data structure may be varied as desired, such that, for example a (single) draw ID or primitive setting is provided with respect to multiple primitives.

The depth samples 45 for a primitive may typically be very similar, and are also likely to be depth samples from neighbouring primitives. As such, the depth samples may be compressed 45, for example using delta compression.

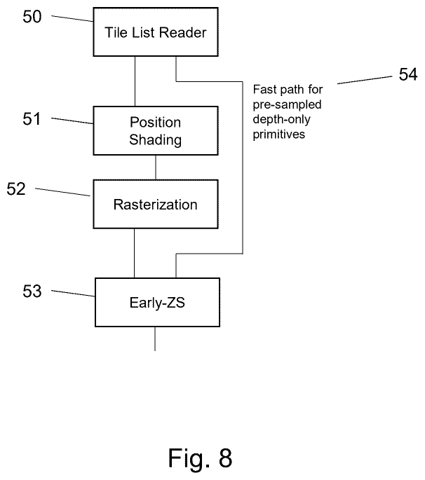

FIG. 8 shows schematically an embodiment of a graphics processing pipeline for using binning data structures generated according to embodiments of the technology described herein.

The pipeline of FIG. 8 includes a tile list reader 50, that uses binning data structures in the form of tile lists to determine primitives to be processed for a rendering tile of a render output being rendered. However, other suitable stages of a graphics processing pipeline for reading the binning data structure may also be used as desired. For example, where the binning data structures comprise (a hierarchy of) bounding boxes, the pipeline may instead comprise a bounding box reading stage that compares a rendering tile to be rendered with the (hierarchy of) bounding boxes to identify primitives to be processed.

In either case, primitives to be processed for a rendering tile are identified.

In the graphics processing pipeline of FIG. 8, for a (and each) primitive identified to be processed for a rendering tile for which no depth has been stored, vertex data for the primitive is fetched (for example on the basis of vertex indices included in the binning data structures) and position shaded 51 to generate transformed vertex position data. This transformed vertex position data for the primitive is then rasterized 52 to generate fragments (which includes determining sampling positions covered by the primitive, and the depths thereof).

The fragments are used to perform an early-Z test 53, and continue to be appropriately fragment shaded to generate output data for the scene.

In accordance with the operation of the technology described herein, some (e.g. “depth only”) primitives may have had a depth at sampling positions covered by the primitive calculated and stored in the binning data structure. As such, the graphics processing pipeline of the present embodiments include a “fast” path for such primitives 54.

Accordingly, the tile list reader 50 (or other appropriate binning data structure reader) identifies whether a depth has been stored with respect to a primitive, and when it is determined that a depth has been stored in a binning structure with respect to a primitive, the depths of the sampling positions are (directly) read from the binning data structure and used for the primitive in the early-Z test 53, without the primitive undergoing position shading 51 or rasterization 52.

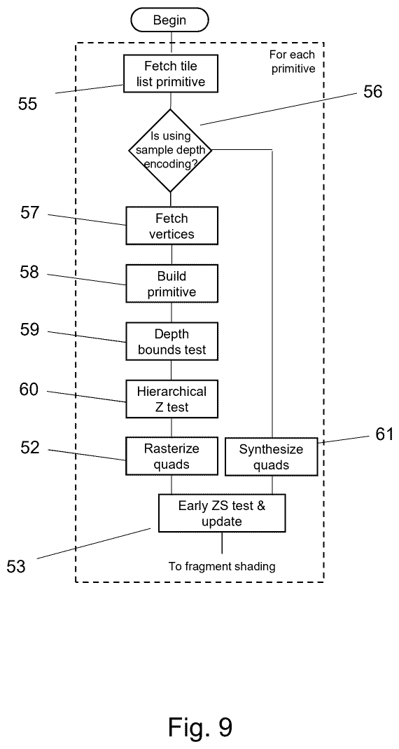

FIG. 9 shows schematically the processing of primitives included in binning data structures, according to embodiments of the technology described herein.

In the operation of FIG. 9, for each primitive included in a binning data structure, the data for the primitive is fetched 55 from the binning data structure. It is then determined whether a depth has been stored with respect to the primitive 56.

If a depth has been stored with respect to the primitive, then this depth is used to synthesise 61 a fragment for the sampling positions covered by the primitive. In the present embodiment, the fragment used for subsequent processing is a “quad” comprising a 2×2 array of sampling positions.

The fragment (in this embodiment quad) is then used to perform an early Z test 53, and then used for fragment shading 62 as desired.

If a depth has not been stored with respect to the primitive, the primitive then undergoes processing to generate suitable fragments to perform fragment shading 62.

First, vertices for the primitive are fetched 57, for example using vertex indices stored in the binning data structure with respect to the primitive. The primitive is then built 58, and a depth bounds test 59 and a hierarchical Z test 60 performed as appropriate.

The primitive is then rasterized 52, in this embodiment to determine sampling position(s) within a fragment (in this embodiment a 2×2 quad of sampling positions) that are covered by a primitive. The fragment is used to perform the early-Z test 53 and any necessary fragment shading 62 as appropriate to generate the render output.

In another embodiment, the graphics processor performs a first processing pass and a second processing pass. The first processing pass includes a binning phase, in which binning data structures are generated, which are used to determine which primitives to process when rendering a rendering tile.

In this embodiment, binning data structure(s) include vertex information for each primitive included therein. Furthermore, for at least some primitives included in data structures, depths of sample positions covered by a primitive are stored with respect to the primitive.

In the first processing pass, the binning data structures are then used to determine which primitives are visible for a rendering tile. This may comprise performing at least hidden surface removal. For primitives for which a depth is included in the binning data structure, the depth is used when determining whether the primitive is visible. This allows the determination of visibility to be performed without requiring any shading, vertex loading, triangle setup or rasterization, and therefore may be performed simply and quickly.

For primitives for which a depth has not been included in the binning data structure, the vertex information is used when determining the visibility of the primitive.

In the second processing pass, “full” processing of primitives is performed to generate a render output. In this embodiment, in the second processing pass, only those primitives determined to be visible in the first processing pass are processed.

In this embodiment, the binning data structures generated during the first processing pass are (also) used in the second processing pass when processing those primitives that have been determined to be visible. In particular, when performing the second processing pass, the vertex information stored in the binning data structure with respect to primitives is used. This may include loading vertex positions identified by the vertex information, performing triangle setup, rasterising the primitive and performing any necessary fragment shading.

Of course, it will be appreciated that when performing the second processing pass, any depths included in the data structures with respect to primitives may be used (e.g. instead of or in addition to the vertex information).

It can be seen from the above that the technology described herein, in its embodiments at least, can provide for reduced latency when generating a rendering output by rendering respective tiles of the render output, and can reduce the bandwidth during rendering. This is achieved, in the embodiments of the technology described herein at least, by storing a depth of the primitive at one or more sampling points covered by the primitive in a binning data structure with respect to the primitive, such that the depth can be read (directly) from the binning data structure when rendering a rendering tile.

Whilst the foregoing detailed description has been presented for the purposes of illustration and description, it is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated. It is intended that the scope be defined by the claims appended hereto.

1. A method of operating a graphics processor when performing tile-based rendering in which a render output to be generated is divided into a plurality of tiles for rendering purposes, with tiles of the render output being rendered separately, the method comprising:
generating binning data structures for identifying primitives to be processed for respective rendering tiles of a render output being generated; and
rendering respective tiles of the render output including using the binning data structures to identify primitives to be processed for rendering tiles;
the method further comprising, when generating binning data structures for identifying primitives to be processed for respective rendering tiles for a render output being generated:
for one or more primitives to be included in a binning data structure:
determining a depth of the primitive at one or more sampling positions that are covered by the primitive; and
including the determined depth or depths of the primitive in the binning data structure with respect to the primitive.

2. The method of claim 1, wherein including the determined depth or depths of the primitive in the binning data structure with respect to the primitive further comprises including in the binning data structure an indication of the position of the covered sampling position or positions within a region of the render output to which the binning data structure corresponds.

3. The method of claim 1, wherein generating binning data structures for identifying primitives to be processed for respective rendering tiles for a render output being generated comprises determining whether to store depths of sampling positions with respect to primitives that the depth or depths are for.

4. The method of claim 1, wherein generating binning data structures for identifying primitives to be processed for respective rendering tiles comprises for one or more primitives to be included in a binning data structure:
determining whether to store a depth with respect to the primitive based on a property of the primitive.

5. The method of claim 4, wherein determining whether to store a depth with respect to a primitive based on a property of the primitive comprises determining the number of sampling positions covered by the primitive and, when the number of sampling positions is less than a threshold number of sampling positions, including a depth of the primitive at covered sampling positions in the binning data structure with respect to the primitive.

6. The method of claim 4, wherein determining whether to store a depth with respect to a primitive based on a property of the primitive comprises determining an area of the primitive and, when the area is less than a threshold area, including a depth in the binning data structure with respect to the primitive.

7. The method of claim 3, wherein when it is determined not to store depths with respect to a primitive to be included in a binning data structure, including vertex information for the primitive in the binning data structure.

8. The method of claim 1, wherein generating a binning data structure for identifying primitives to be processed for a rendering tile comprises compressing the determined depth or depths.

9. The method of claim 1, wherein rendering a tile of a render output by using a binning data structure to determine primitives to be processed for the rendering tile comprises:
using the binning data structure to identify primitives to be processed for the rendering tile;
determining whether a depth has been stored with respect to a primitive identified to be processed; and
when a depth has been stored with respect to a primitive, using the depth when rendering the rendering tile.

10. A method of operating a graphics processor when rendering a rendering tile of a render output by using a binning data structure to identify primitives to be processed for the rendering tile, in which the graphics processor is operable to, for one or more primitives to be included in a binning data structure, store a depth or depths of a primitive at one or more sampling positions covered by the primitive in the binning data structure with respect to the primitive, the method comprising:
using the binning data structure to identify primitives to be processed for the rendering tile; and
for one or more primitives identified to be processed for the rendering tile for which a depth has been included in the data structure with respect to the primitive:
reading a depth from the binning data structure with respect to the primitive, and
using the read depth when rendering the rendering tile.

11. A graphics processor operable to perform tile-based rendering, in which a render output to be generated is divided into a plurality of tiles for rendering purposes, with tiles of the render output being rendered separately, the graphics processor comprising:
a binning circuit configured to generate binning data structures for identifying primitives to be processed for respective rendering tiles of a render output being generated;
a rendering circuit configured to render respective tiles of the render output and use the binning data structures to identify primitives to be processed for rendering tiles; and
a depth determining circuit configured to determine a depth of a primitive at one or more sampling positions covered by the primitive;
wherein the binning circuit is operable to, when generating binning data structures for identifying primitives to be processed for respective rendering tiles for a render output:
include in a binning data structure with respect to a primitive, a depth of the primitive at a sampling position that is covered by the primitive determined by the depth determining circuit.

12. The graphics processor of claim 11, wherein the binning circuit is further configured to include in a binning data structure with respect to a primitive for which a depth of the primitive at a sampling position that is covered by the primitive determined by the depth determining circuit is included in the binning data structure, an indication of the position of the covered sampling position within a region of the render output to which the binning data structure corresponds that the depth is for.

13. The graphics processor of claim 11, wherein the binning circuit is configured to, when generating binning data structures for identifying primitives to be processed for respective rendering tiles for a render output being generated, determine whether to store depths of sampling positions with respect to primitives.

14. The graphics processor of claim 11, wherein the binning circuit is configured to, when generating binning data structures for identifying primitives to be processed for respective rendering tiles for a render output being generated, for one or more primitives to be included in a binning data structure:
determine whether to store a depth with respect to the primitive based on a property of the primitive.

15. The graphics processor of claim 14, wherein the binning circuit is configured to, when determining whether to store a depth with respect to a primitive based on a property of the primitive, determine by the depth determining circuit the number of sampling positions covered by the primitive and, when the number of sampling positions is less than a threshold number of sampling positions, include a depth of the primitive at covered sampling positions in the binning data structure with respect to the primitive.

16. The graphics processor of claim 14, wherein the binning circuit is configured to, when determining whether to store a depth with respect to a primitive based on a property of the primitive, determine an area of the primitive and, when the area is less than a threshold area, include a depth in the binning data structure with respect to the primitive.

17. The graphics processor of claim 13, wherein the binning circuit is configured to, when it is determined not to store a depth or depths with respect to a primitive to be included in a binning data structure, store vertex information for the primitive in the binning data structure.

18. The graphics processor of claim 11, wherein the binning circuit is configured to, when generating a binning data structure for identifying primitives to be processed for a rendering tile, compress the determined depth or depths.

19. The graphics processor of claim 11, wherein the rendering circuit is configured to, when rendering a tile of a render output by using a binning data structure to determine primitives to be processed for the rendering tile:
use the binning data structure to identify primitives to be processed for the rendering tile;
determine whether a depth has been stored with respect to a primitive identified to be processed; and
when a depth has been stored with respect to a primitive, use the stored depth when rendering the rendering tile.

20. A non-transitory computer readable storage medium storing computer software code which when executing on at least one processor, performs a method of operating a graphics processor when performing tile-based rendering in which a render output to be generated is divided into a plurality of tiles for rendering purposes, with tiles of the render output being rendered separately, the method comprising:
generating binning data structures for identifying primitives to be processed for respective rendering tiles of a render output being generated; and
rendering respective tiles of the render output including using the binning data structures to identify primitives to be processed for rendering tiles;
the method further comprising, when generating binning data structures for identifying primitives to be processed for respective rendering tiles for a render output being generated:
for one or more primitives to be included in a binning data structure:
determining a depth of the primitive at one or more sampling positions that are covered by the primitive; and
including the determined depth or depths of the primitive in the binning data structure with respect to the primitive.
